(19) United States
(12) Patent Application Publication
(10) Pub. No.: US 2004/0052916 A1
(43) Pub. Date: Mar. 18, 2004

(54) Bread utilizing vegetables for their nutritional value and method for making

(76) Inventor: Sook Hee Ree, Roslyn, NY (US)

Correspondence Address: RICHARD L. MILLER, 12 Parkside Drive, Dix Hills, NY, 11746-4879, US

(21) Appl. No.: 10/244,300

(22) Filed: Sep. 16, 2002

(51) Int. Cl. A21D 10/00

(52) U.S. Cl. 426/549

(57) ABSTRACT

A bread utilizing vegetables for their nutritional value and which includes powdered vegetables, concentrated liquid vegetables, powdered grains, and dehydrated diced vegetables, and methods for preparing the powdered vegetables, the concentrated liquid vegetables, the powdered grains, the dehydrated diced vegetables, and the bread utilizing vegetables for their nutritional value in non-yeast and yeast types.

### BACKGROUND OF THE INVENTION

1. Field of the Invention

The present invention relates to a bread. More particularly, the present invention relates to a bread utilizing vegetables for their nutritional value and method for making.

2. Description of the Prior Art

Numerous innovations for breads have been provided in the prior art. Even though these innovations may be suitable for the specific individual purposes to which they address, however, they differ from the present invention.

A FIRST EXAMPLE, U.S. Pat. No. 3,615,655 to Freeman teaches a protein rich product which is particularly useful for human consumption is prepared from a cereal grain by rupturing the cells of the cereal grain germ, abrading the ruptured germ to free adherent protein particles from the remainder of the germ cell fragments, and separating out a protein rich fraction low in fiber content from a protein lean germ residue fraction, relatively high in fibrous type materials.

A SECOND EXAMPLE, U.S. Pat. No. 4,599,240 to Thompson teaches a process is provided for the processing of certain organic agricultural foodstuff by-products normally having little commercial value to produce a cellulosic product suitable for human consumption or use in various products. The process of the present invention is characterized by subjecting a variety of certain agricultural by-products having little commercial value, such as, for example, soybean hulls, to a series of steps utilizing certain chemical treating to effect a solubilizing and removal of the non-cellulosic components of the byproduct agricultural material to produce residue solids which consist essentially of cellulose. The cellulose residue solids are subjected to specified purification procedures and thereafter dried to produce a short, fine fibered cellulose which may be processed to a fine powdered state suitable for use as a component part in a wide variety of edible or otherwise useable products by humans, an example of such a product being a low calorie bread.

A THIRD EXAMPLE, U.S. Pat. No. 5,234,706 to Slimak teaches a variety of different food products, prepared from edible roots, seeds, and starchy fruits including potatoes, arrowroot, water chestnut, jicama, buckwheat, legumes, millet, milo, barley, oats, corn, teff, rice, cotton seed meal, bread fruit, pumpkin, winter squash, white squash, plantain, banana, and jack fruit are substitutes for wheat and other grains, milk, eggs, and a partial substitute for nuts. A variety of starches, soluble fibers may be combined to provide products that are substitutes for wheat and other grains, milk, eggs, and a partial substitute for nuts.

A FOURTH EXAMPLE, U.S. Pat. No. 5,275,833 to Schmidt teaches high dietary fiber from sources that have had minimal use in food products, for example bakery goods, extruded items and pasta, for humans because of their green coloration and inherent flavors. The fibrous material is immersed in an aqueous dispersion of chlorine for a period of time with a concentration of chlorine that is effective for removing substantially all of the coloration from the material with a minimal effect on the fiber matrix, for example three to thirty minutes with one part fiber to five parts water and about 13,500 to 62,400 ppm chlorine. Advantageously, the thurs bleached material is then water rinsed and immersed in a 4-50% aqueous solution of peroxide at a temperature of about room temperature to boiling for up to about 15 minutes or until the fiber flavor and chlorine backnotes are rendered blander. the fibrous material is treated in a peroxide solution of at least about 4% peroxide concentration at an elevated temperature for at least about 5 minutes to bleach and deflavor the fibrous material.

A FIFTH EXAMPLE, U.S. Pat. No. 5,789,012 to Slimak teaches flours prepared from white sweet potatoes, cassaya, edible aroids, tropical yams, lotus, arrowhead, buckbean, and amaranth, and a variety of different food products prepared from them, are substitutes for wheat and other grains, legumes, milk, eggs, and a partial substitute for nuts. A variety of different food products, prepared from edible roots, seeds, and starchy fruits including potatoes, arrowroot, water chestnut, sugar beets, jicama, buckwheat, legumes, millet, milo, barley, oats, corn, teff, rice, cotton seed meal, bread fruit, pumpkin, winter squash, white squash, plantain, banana, and jack fruit, are substitutes for wheat and other rains, milk, eggs, and a partial substitute for nuts. A variety of starches, soluble fibers, and insoluble fibers may be combined to provide products that are substitutes for wheat and other grains, milk, eggs, and a partial substitute for nuts.

A SIXTH EXAMPLE, U.S. Pat. No. 6,322,826 B2 to Zohoungbogbo teaches food composition in the form of a flour comprising at least 50% of protein, less than 15% of carbohydrates and 35 to 50% of plant fibers; preferably the carbohydrate content is less than 10%, advantageously less than 5%; this composition may be used as a substitute for wheat flour in the preparation of foods such as pasta, bread, bread sticks, bakery products and pastries and constitutes the basis of a method for improving the appearance of a person by achieving a loss of weight which is beneficial from the aesthetic point of view.

### SUMMARY OF THE INVENTION

ACCORDINGLY, AN OBJECT of the present invention is to provide a bread utilizing vegetables for their nutritional value and method for making that avoids the disadvantages of the prior art.

ANOTHER OBJECT of the present invention is to provide a bread utilizing vegetables for their nutritional value and method for making that is simple and inexpensive to manufacture.

STILL ANOTHER OBJECT of the present invention is to provide a bread utilizing vegetables for their nutritional value and method for making that is simple to use.

BRIEFLY STATED, STILL YET ANOTHER OBJECT of the present invention is to provide a bread utilizing vegetables for their nutritional value and which includes powdered vegetables, concentrated liquid vegetables, powdered grains, and dehydrated diced vegetables, and methods for preparing the powdered vegetables, the concentrated liquid vegetables, the powdered grains, the dehydrated diced vegetables, and the salad bread in non-yeast and yeast types.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE TABLES

The tables in the specification are briefly described as follows:

TABLE I is a tabulation of the vegetables and their corresponding quantities of the powdered vegetables for use in the bread utilizing vegetables for their nutritional value of the present invention;

TABLE II is a tabulation of the vegetables and their corresponding quantities of the concentrated liquid vegetables for use in the bread utilizing vegetables for their nutritional value of the present invention;

TABLE III is a tabulation of the grains and their corresponding quantities of the powdered grains for use in the bread utilizing vegetables for their nutritional value of the present invention;

TABLE IV is a tabulation of the vegetables and their corresponding quantities of the dehydrated diced vegetables for use in the bread utilizing vegetables for their nutritional value of the present invention;

TABLE V is a tabulation of the ingredients and their corresponding quantities for use in the non-yeast type bread utilizing vegetables for their nutritional value of the present invention; and

TABLE VI is a tabulation of the ingredients and their corresponding quantities for use in the yeast type bread utilizing vegetables for their nutritional value of the present invention;

### BRIEF DESCRIPTION OF THE DRAWING

The figures of the drawing are briefly described as follows:

FIG. 1 is a flow chart for the method of preparing the powdered vegetables for use in the bread utilizing vegetables for their nutritional value of the present invention;

FIGS. 2A-2D are a flow chart for the method of preparing the concentrated liquid vegetables for use in the bread utilizing vegetables for their nutritional value of the present invention;

FIG. 3 is a flow chart for the method of preparing the powdered grains for use in the bread utilizing vegetables for their nutritional value of the present invention;

FIG. 4 is a flow chart for the method of preparing the dehydrated diced vegetables for use in the bread utilizing vegetables for their nutritional value of the present invention;

FIGS. 5A-5D is a flow chart for the method of preparing the bread utilizing vegetables for their nutritional value when formed as a non-yeast type; and

FIGS. 6A-6E is a flow chart for the method of preparing the bread utilizing vegetables for their nutritional value when formed as a yeast type.

### DESCRIPTION OF THE PREFERRED EMBODIMENT

The bread utilizing vegetables for their nutritional value of the present invention comprises powdered vegetables (TABLE I), concentrated liquid vegetables (TABLE II), powdered grains (TABLE III), and dehydrated diced vegetables (TABLE IV), as appear at the end of this section.

The bread utilizing vegetables for their nutritional value when formed as a non-yeast type further comprises the ingredients of TABLE V, as appears at the end of this section.

The bread utilizing vegetables for their nutritional value when formed as a yeast type further comprises the ingredients of TABLE VI, as appears at the end of this section.

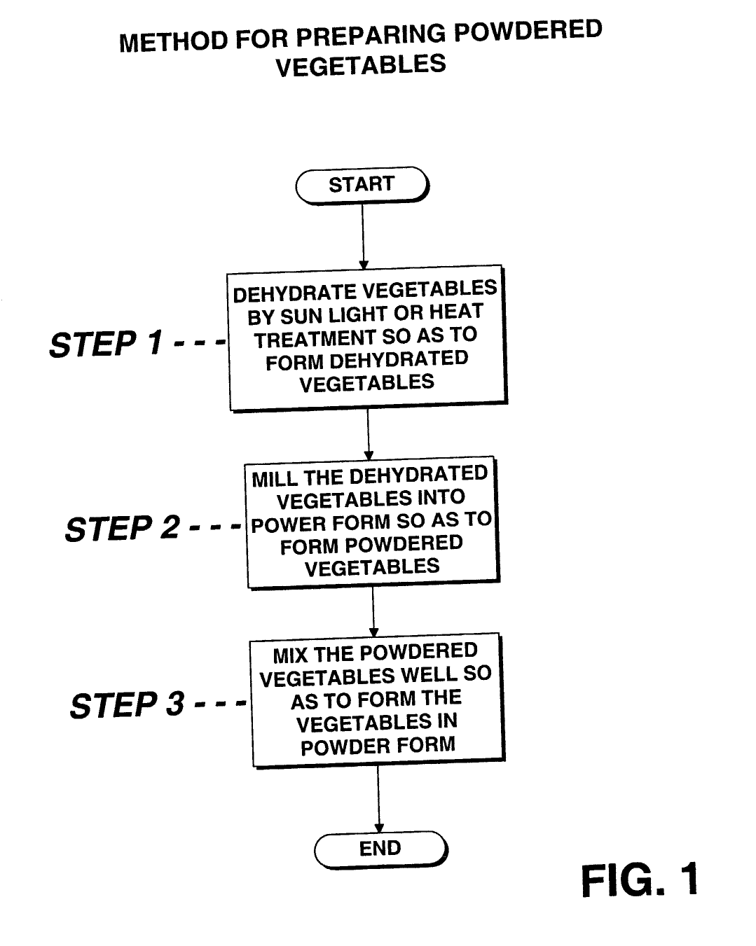

The method for preparing the powdered vegetables for use in the bread utilizing vegetables for their nutritional value of the present invention can best be seen in FIG. 1, and as such, will be discussed with reference thereto.

| | |
|---|---|
| STEP 1: | Dehydrate the vegetables by sun light or heat treatment so as |
| | to form dehydrated vegetables. |
| STEP 2: | Mill the dehydrated vegetables into power form so as to form |
| | powdered vegetables. |
| STEP 3: | Mix the powdered vegetables well so as to form the vegetables |
| | in powder form. |

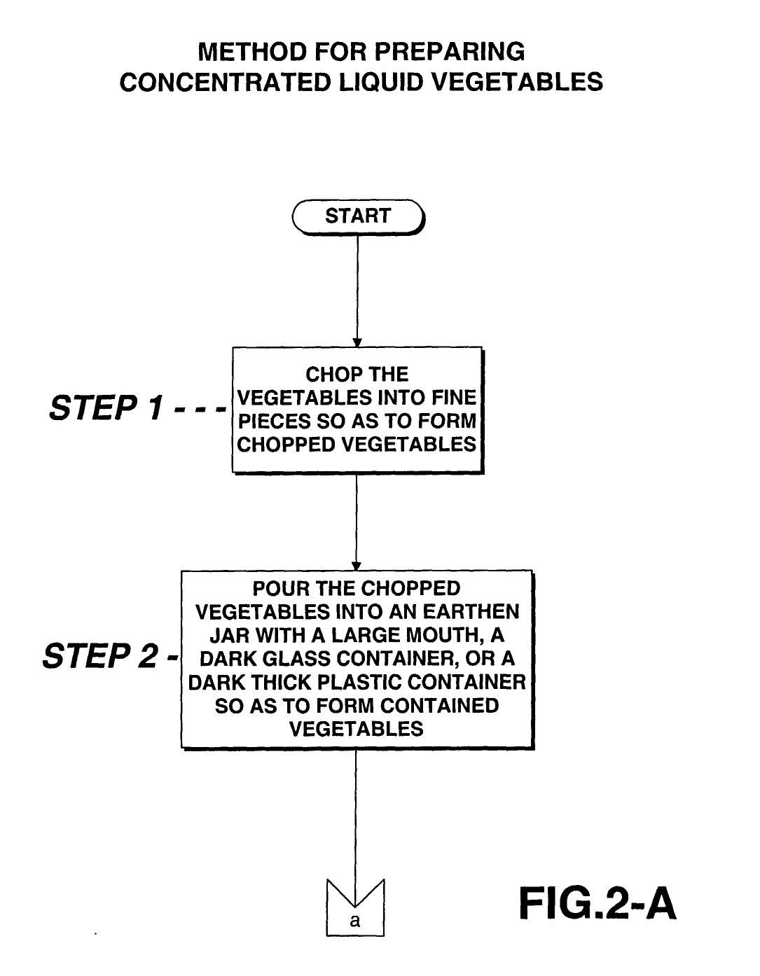

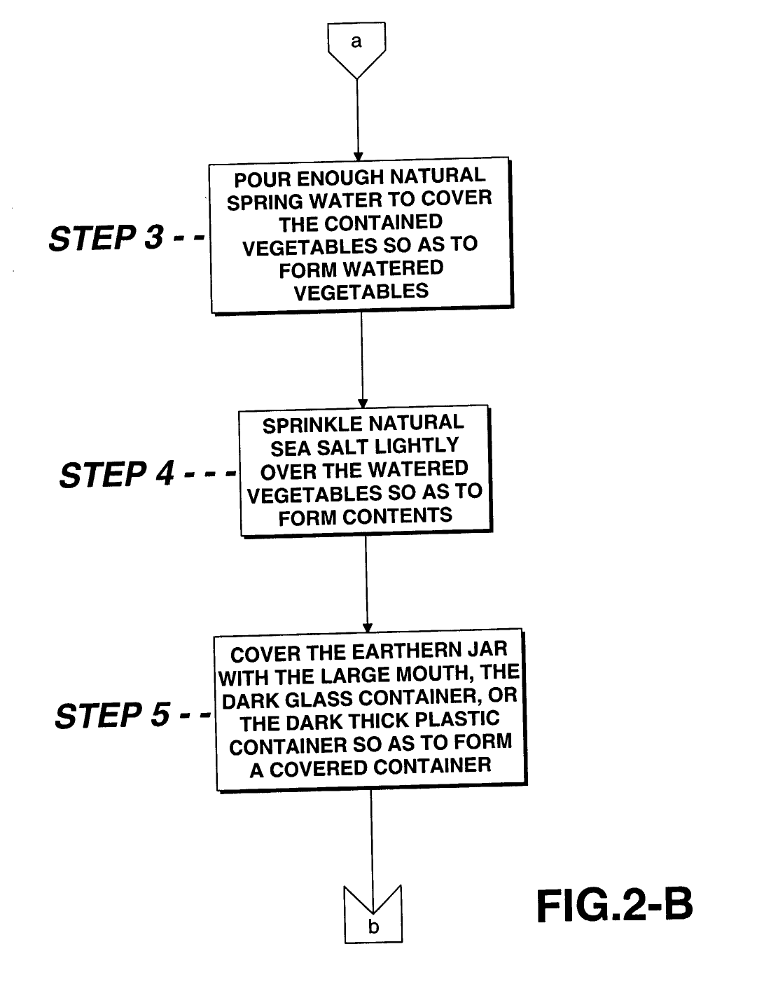

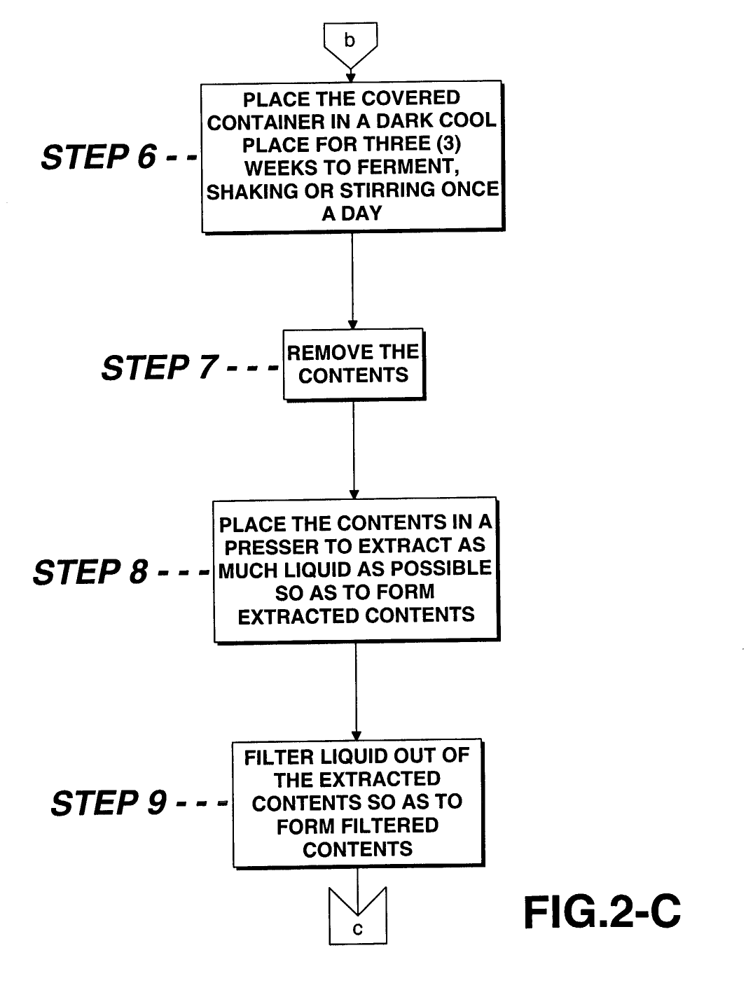

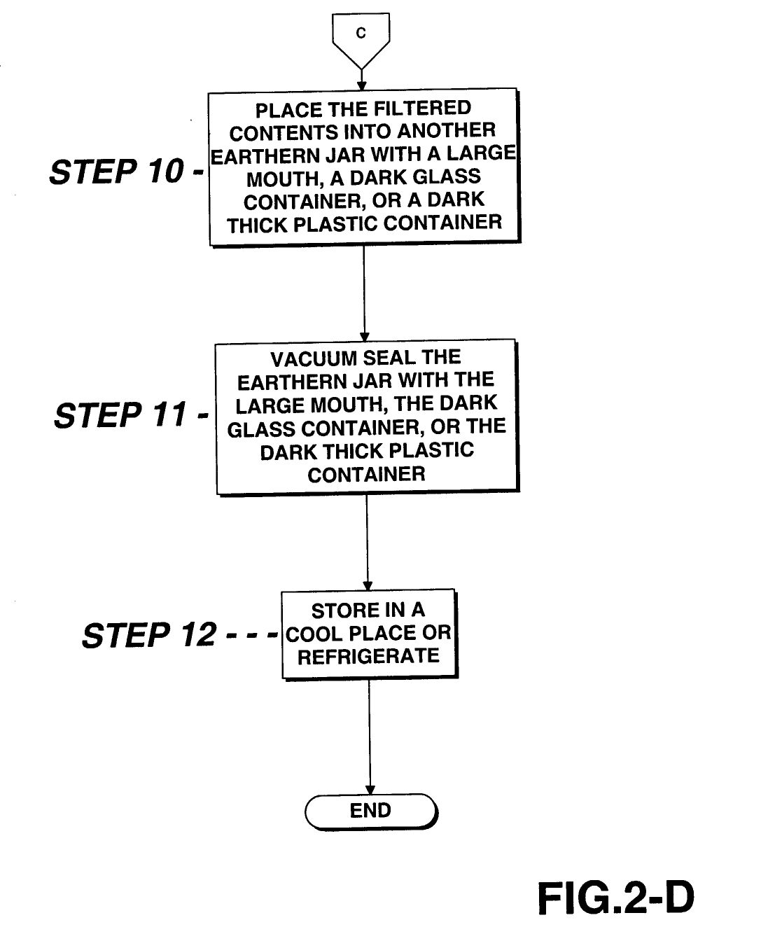

The method for preparing the concentrated liquid vegetables for use in the bread utilizing vegetables for their nutritional value of the present invention can best be seen in FIGS. 2A-2D, and as such, will be discussed with reference thereto.

| | |
|---|---|
| STEP 1: | Chop the vegetables into fine pieces so as to form chopped |
| | vegetables. |
| STEP 2: | Pour the chopped vegetables into an earthen jar with a large |
| | mouth, a dark glass container, or a dark thick plastic |
| | container so as to form contained vegetables. |
| STEP 3: | Pour enough natural spring water to cover the contained |
| | vegetables so as to form watered vegetables. |
| STEP 4: | Sprinkle natural sea salt lightly over the watered vegetables |
| | so as to form contents. |
| STEP 5 | Cover the earthen jar with the large mouth, the dark glass |
| | container, or the dark thick plastic container so as to form |
| | a covered container. |
| STEP 6: | Place the covered container in a dark cool place for three (3) |
| | weeks to ferment, shaking or stirring once a day. |
| STEP 7: | Remove the contents. |
| STEP 8: | Place the contents in a presser to extract as much liquid as |
| | possible so as to form extracted contents. |
| STEP 9: | Filter liquid out of the extracted contents so as to form |
| | filtered contents. |
| STEP 10: | Place the filtered contents into another earthen jar with a |
| | large mouth, a dark glass container, or a dark thick plastic |
| | container. |
| STEP 11: | Vacuum seal the earthen jar with the large mouth, the dark |
| | glass container, or the dark thick plastic container. |
| STEP 12: | Store in a cool place or refrigerate. |

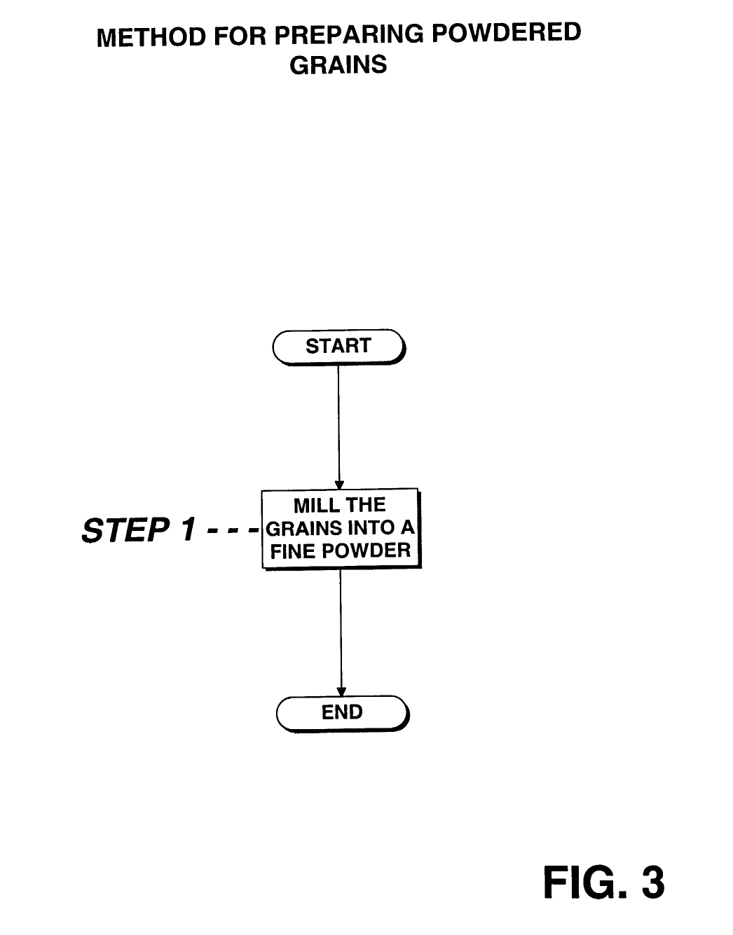

The method for preparing the powdered grains for use in the bread utilizing vegetables for their nutritional value of the present invention can best be seen in FIG. 3, and as such, will be discussed with reference thereto.

STEP 1: Mill the Grains Into a Fine Powder.

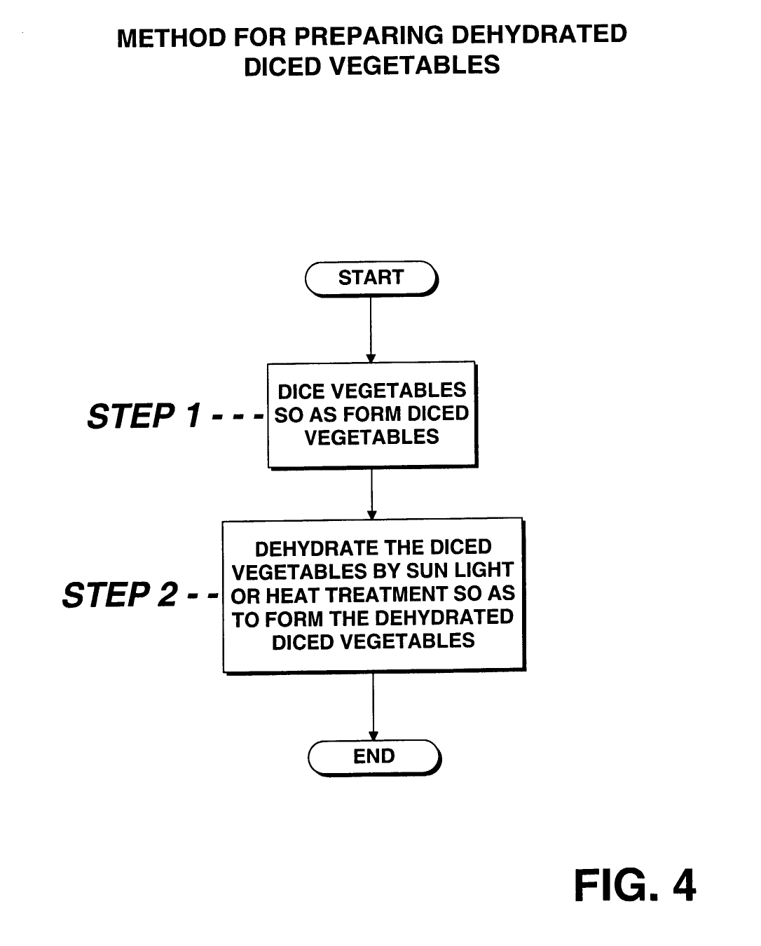

The method for preparing the dehydrated diced vegetables for use in the bread utilizing vegetables for their nutritional value of the present invention can best be seen in FIG. 4, and as such, will be discussed with reference thereto.

| | |
|---|---|
| STEP 1: | Dice the vegetables so as form diced vegetables. |
| STEP 2: | Dehydrate the diced vegetables by sun light or heat treatment |
| | so as to form the dehydrated diced vegetables. |

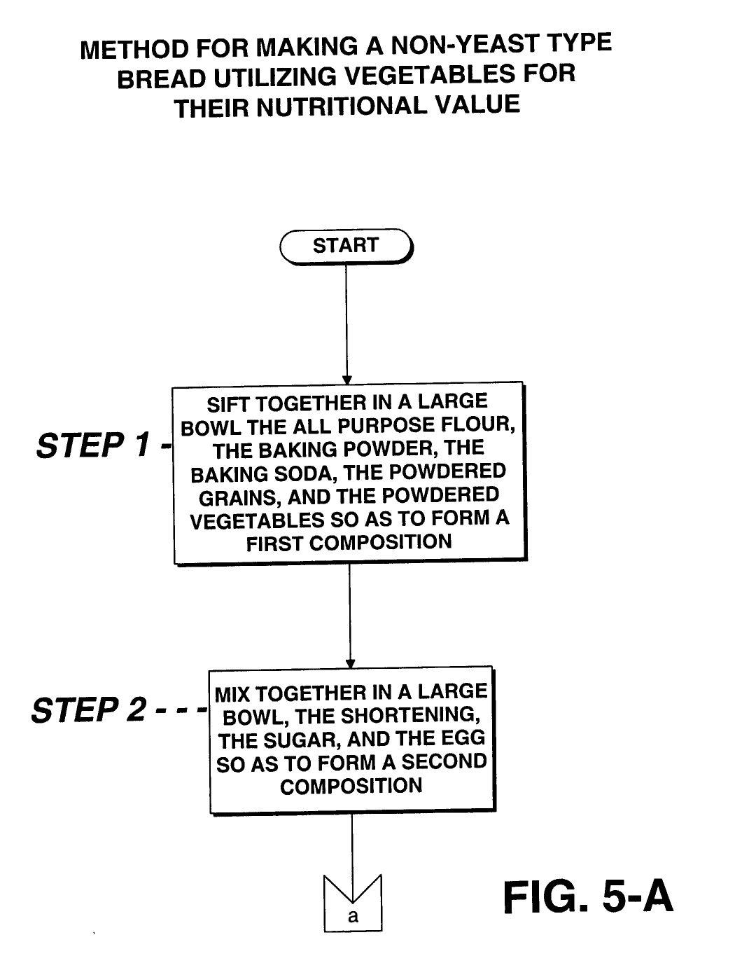

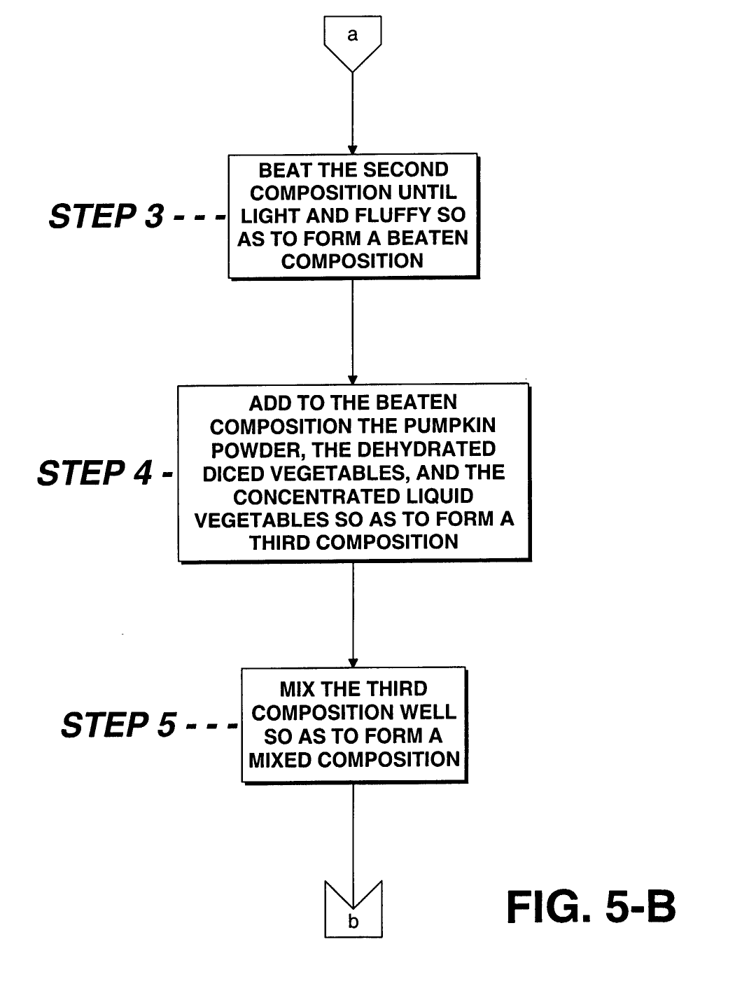

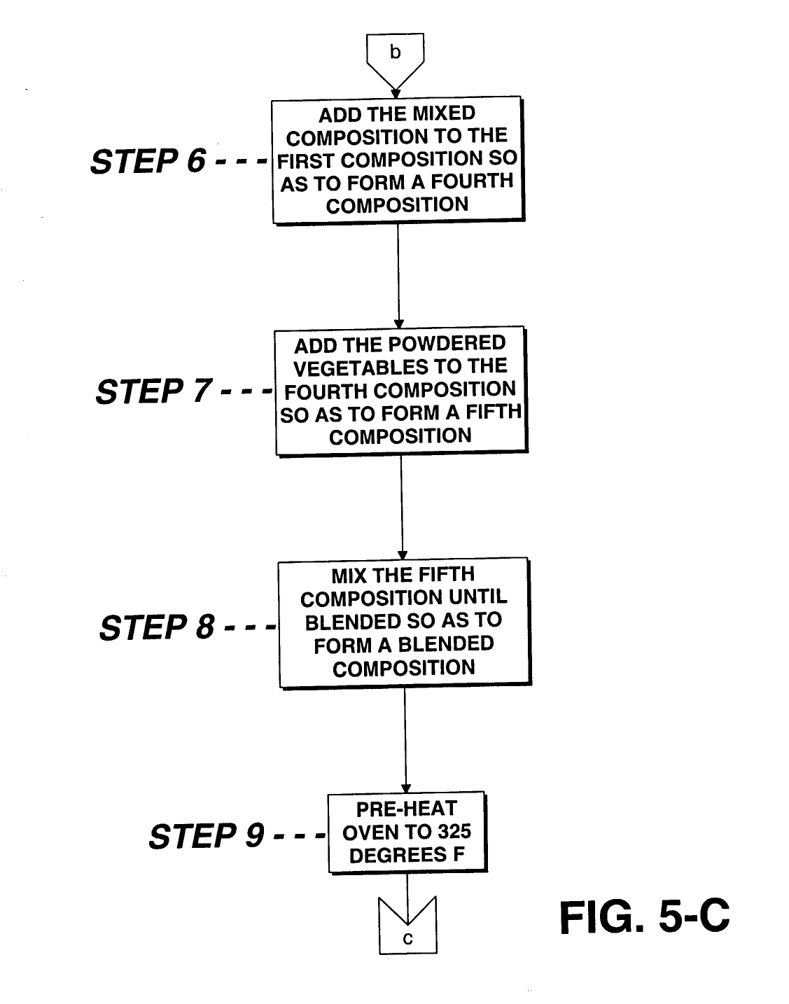

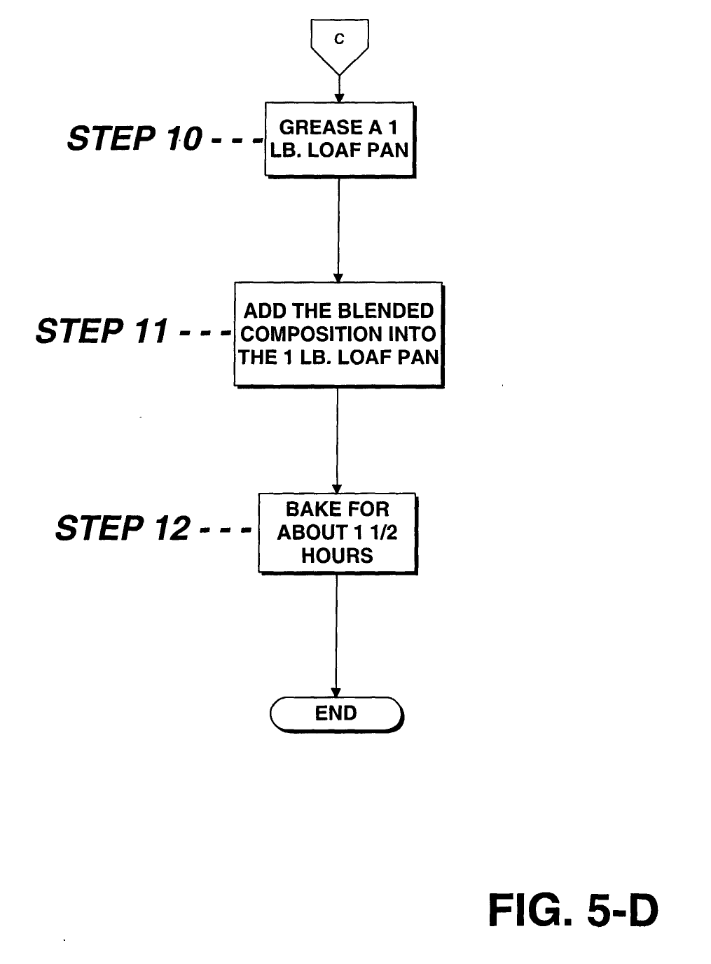

The method for making the bread utilizing vegetables for their nutritional value when formed as a non-yeast type can best be seen in FIGS. 5A-5D, and as such, will be discussed with reference thereto.

| | |
|---|---|
| STEP 1: | Sift together in a large bowl the all purpose flour, the |
| | baking powder, the baking soda, the powdered grains, and the |
| | powdered vegetables so as to form a first composition. |
| STEP 2: | Mix together in another large bowl, the shortening, the sugar, |
| | and the egg so as to form a second composition. |
| STEP 3: | Beat the second composition until light and fluffy so as to |
| | form a beaten composition. |
| STEP 4: | Add to the beaten composition the pumpkin powder, the |
| | dehydrated diced vegetables, and the concentrated liquid |
| | vegetables so as to form a third composition. |
| STEP 5: | Mix the third composition well so as to form a mixed |
| | composition. |
| STEP 6: | Add the mixed composition to the first composition so as to |
| | form a fourth composition. |
| STEP 7: | Add the powdered vegetables to the fourth composition so as |
| | to form a fifth composition. |
| STEP 8: | Mix the fifth composition until blended so as to form a |
| | blended composition. |
| STEP 9: | Pre-heat oven to 325 degrees F. |
| STEP 10: | Grease a 1 lb. loaf pan. |
| STEP 11: | Add the blended composition into the 1 lb. loaf pan. |
| STEP 12: | Bake for about 1½ hours. |

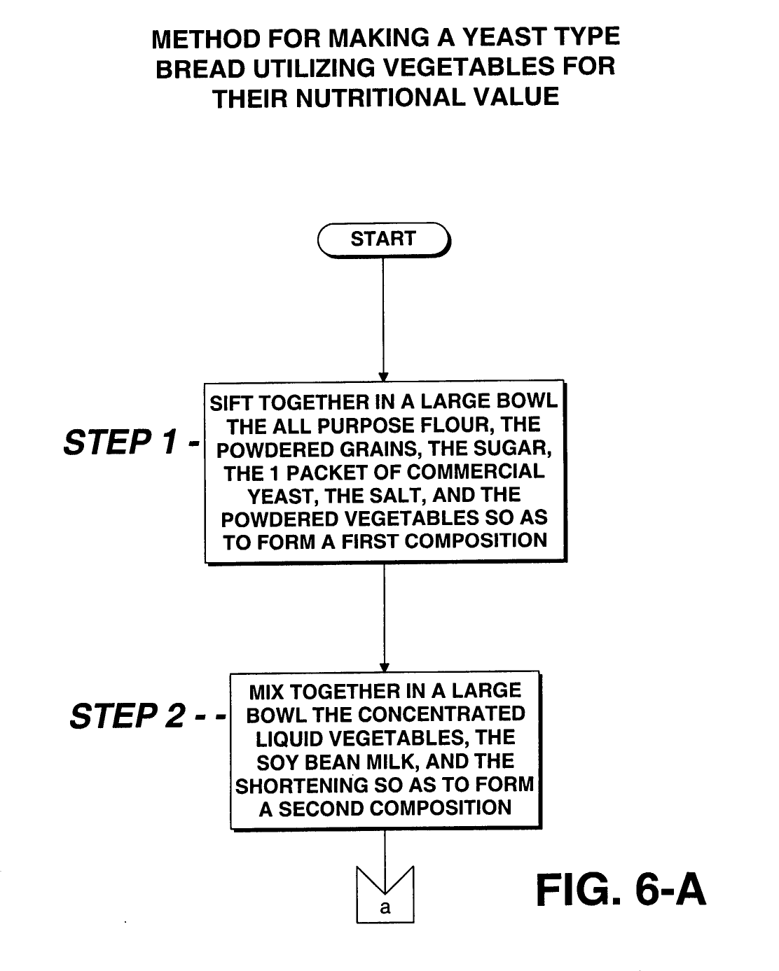

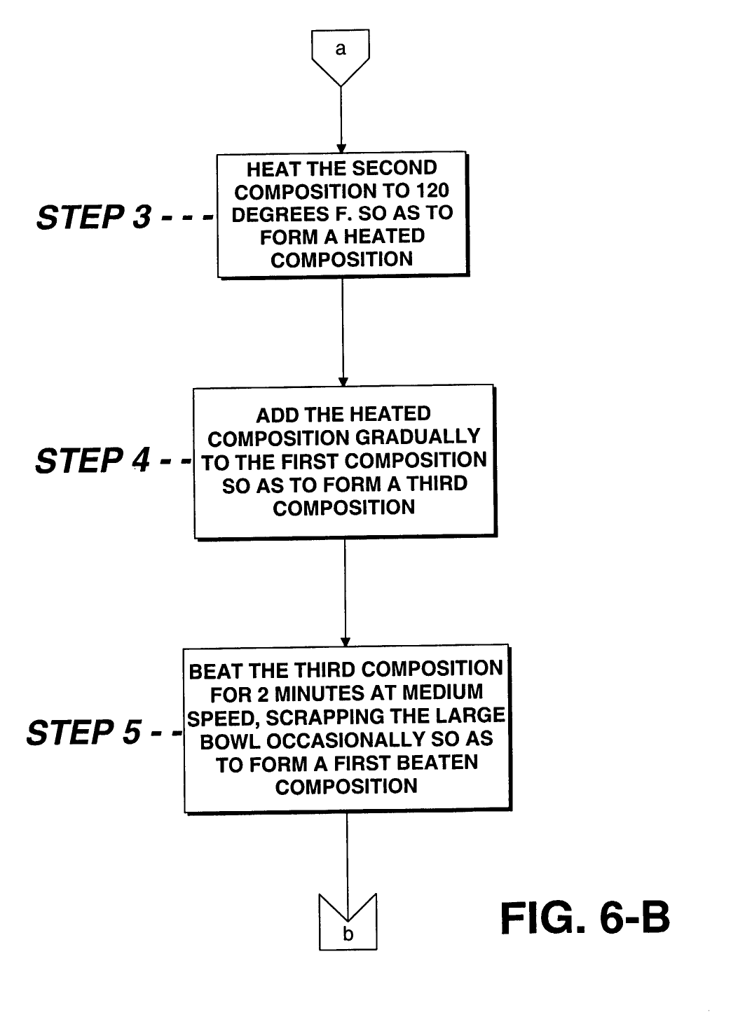

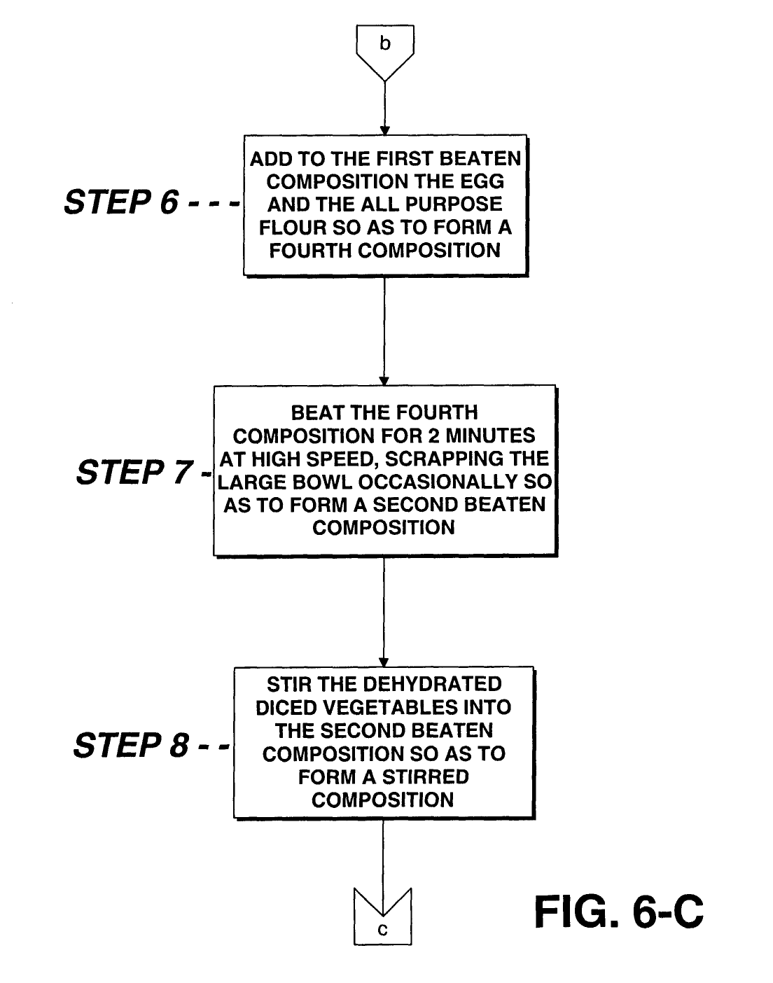

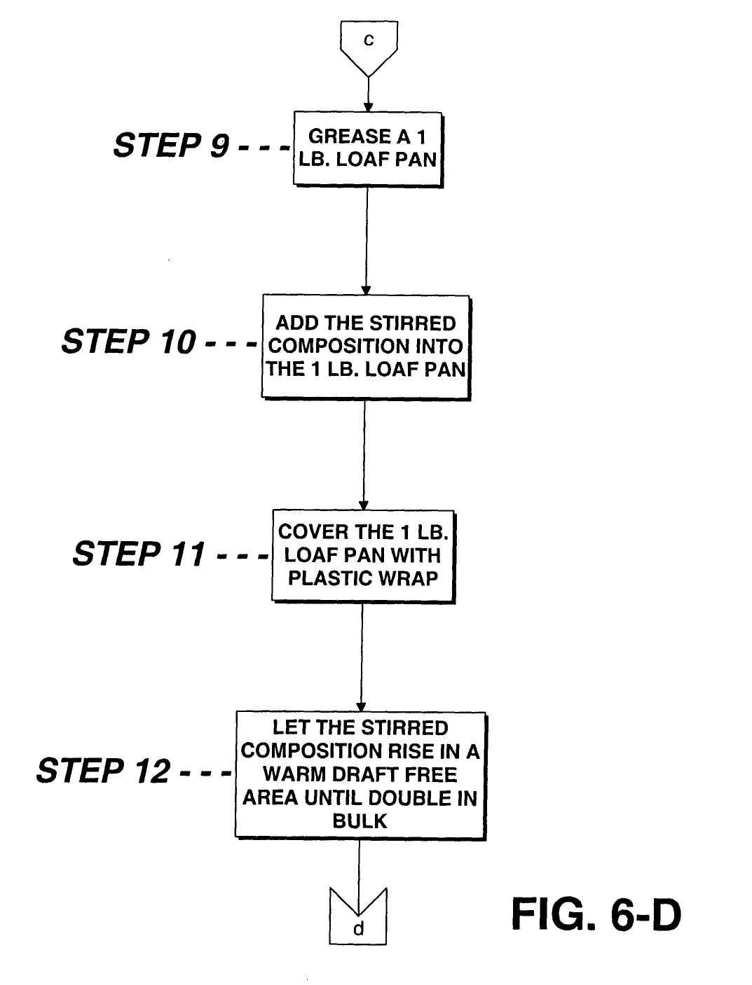

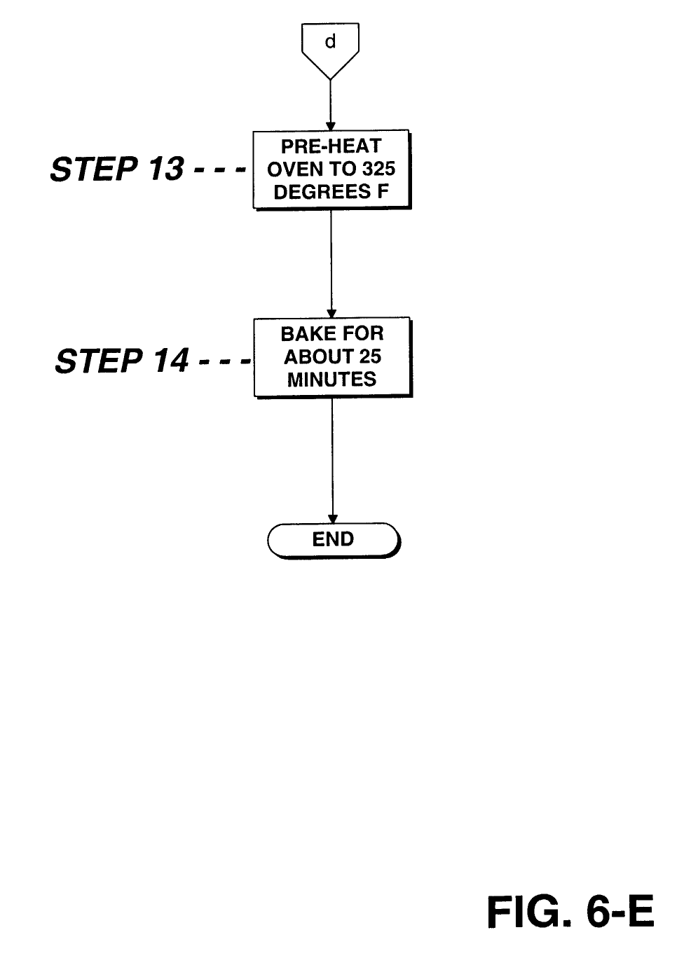

The method for making the bread utilizing vegetables for their nutritional value when formed as a yeast type can best be seen in FIGS. 6A-6E, and as such, will be discussed with reference thereto.

| | |
|---|---|
| STEP 1: | Sift together in a large bowl the all purpose flour, the |
| | powdered grains, the sugar, the 1 packet of commercial yeast, |
| | the salt, and the powdered vegetables so as to form a first |
| | composition. |
| STEP 2: | Mix together in another large bowl the concentrated liquid |
| | vegetables, the soy bean milk, and the shortening so as to |
| | form a second composition. |
| STEP 3: | Heat the second composition to 120 degrees F. so as to form |
| | a heated composition. |
| STEP 4: | Add the heated composition gradually to the first composition |
| | so as to form a third composition. |
| STEP 5: | Beat the third composition for 2 minutes at medium speed, |
| | scrapping the large bowl occasionally so as to form a first |
| | beaten composition. |
| STEP 6: | Add to the first beaten composition the egg and the all |
| | purpose flour so as to form a fourth composition. |
| STEP 7: | Beat the fourth composition for 2 minutes at high speed, |
| | scrapping the large bowl occasionally so as to form a second |
| | beaten composition. |
| STEP 8: | Stir the dehydrated diced vegetables into the second beaten |
| | composition so as to form a stirred composition. |
| STEP 9: | Grease a 1 lb. loaf pan. |
| STEP 10 | Add the stirred composition into the 1 lb. loaf pan. |
| STEP 11: | Cover the 1 lb. loaf pan with plastic wrap. |
| STEP 12: | Let the stirred composition rise in a warm draft free area |
| | until double in bulk. |
| STEP 13: | Pre-heat oven to 325 degrees F. |
| STEP 14: | Bake for about 25 minutes. |

It will be understood that each of the elements described above, or two or more together, may also find a useful application in other types of constructions differing from the types described above.

While the invention has been illustrated and described as embodied in a bread utilizing vegetables for their nutritional value and method for making, however, it is not limited to the details shown, since it will be that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

TABLE I
POWDERED VEGETABLES

| VEGETABLE | QUANTITY IN LBS. |
|---|---|
| Alfalfa | 1 |
| Asparagus | 1 |
| Cauliflower | 1 |
| Brussel Sprouts | 1 |
| Broccoli | 1 |
| Bell Peppers | 1 |
| Lettuce | 1 |
| Kale | 1 |
| Onions | 1 |
| Summer Squash | 1 |
| Cucumbers | 1 |
| Shiitake Mushrooms | 1 |
| Turnips | 1 |
| Fennel | 1 |
| Peas | 1 |
| Scallions | 1 |
| Red Beets | 1 |
| Carrots | 1 |
| Tomatoes | 1 |
| Spinach | 1 |
| Radishes | 1 |
| Sea tangles (kelp) | 2 |
| Celery | 1 |

TABLE II
CONCENTRATED LIQUID VEGETABLES

| VEGETABLE | QUANTITY IN LBS. |
|---|---|
| Alfalfa | 1 |
| Asparagus | 1 |
| Cauliflower | 1 |
| Brussel Sprouts | 1 |
| Broccoli | 1 |
| Bell Peppers | 1 |
| Lettuce | 1 |
| Kale | 1 |
| Onions | 1 |
| Summer Squash | 1 |
| Cucumbers | 1 |
| Shiitake Mushrooms | 1 |
| Turnips | 1 |
| Fennel | 1 |
| Peas | 1 |
| Scallions | 1 |
| Red Beets | 1 |
| Carrots | 1 |
| Tomatoes | 1 |
| Spinach | 1 |
| Radishes | 1 |
| Sea tangles (kelp) | 2 |
| Celery | 1 |

TABLE III
POWDERED GRAINS

| GRAIN | QUANTITY IN LBS |
|---|---|
| Brown Rice | 1 |
| Brown Rice Bran | 1 |
| Wheat | 1 |
| Wheat Bran | 1 |
| Barley | 1 |
| Fermented Soy Beans | 1 |

TABLE IV
DEHYDRATED DICED VEGETABLES

| VEGETABLE | QUANTITY IN LBS |
|---|---|
| Daikon | 1 |
| Carrots | 1 |
| Onions | 1 |
| Pickled Olives | 1 |
| Pickled Cucumbers | 1 |

TABLE V
NON-YEAST TYPE

| | |
|---|---|
| INGREDIENT | QUANTITY |

| | | |
|---|---|---|
| All Purpose Flour | 3 | cups |
| Baking Powder | 1 | teaspoon |
| Baking Soda | 2 | teaspoons |
| Salt | ¼ | teaspoon |
| Sugar | 4 | tablespoons |
| Shortening | ⅔ | cup |
| Large Eggs | 4 | |
| Pumpkin Powder | ½ | cup |

TABLE VI
YEAST TYPE

| | |
|---|---|
| INGREDIENT | QUANTITY |

| | | |
|---|---|---|
| All Purpose Flour | 1 ½ | cups |
| Salt | ¼ | teaspoon |
| Sugar | 4 | tablespoons |
| Shortening | ⅓ | cups |
| Large Egg | 1 | |
| Yeast | 1 | commercial packet |
| Soy Bean Milk | ½ | cup |
| Pumpkin Powder | ½ | cup |

The invention claimed is:

1. A bread utilizing vegetables for their nutritional value, comprising:
a) powdered vegetables;
b) concentrated liquid vegetables;
c) powdered grains; and
d) dehydrated diced vegetables.

2. The bread as defined in claim 1, wherein said powdered vegetables comprise:
a) alfalfa;
b) asparagus;
c) cauliflower;
d) brussel sprouts;
e) broccoli;
f) bell peppers;
g) lettuce;
h) kale;
i) onions;
j) summer squash;
k) cucumbers;
l) shiitake mushrooms;
m) turnips;
n) fennel;
o) peas;
p) scallions;
q) red beets;
r) carrots;
s) tomatoes;
t) spinach;
u) radishes;
v) sea tangles (kelp); and
w) celery.

3. The bread as defined in claim 2, wherein said concentrated liquid vegetables comprise:
a) alfalfa;
b) asparagus;
c) cauliflower;
d) brussel sprouts;
e) broccoli;
f) bell peppers;
g) lettuce;
h) kale;
i) onions;
j) summer squash;
k) cucumbers;
l) shiitake mushrooms;
m) turnips;
n) fennel;
o) peas;
p) scallions;
q) red beets;
r) carrots;
s) tomatoes;
t) spinach;
u) radishes;
v) sea tangles (kelp); and
w) celery.

4. The bread as defined in claim 3, wherein said powdered grains comprise:
a) brown rice;
b) brown rice bran;
c) wheat;
d) wheat bran;
e) barley; and
f) fermented soy beans.

5. The bread as defined in claim 4, wherein said dehydrated diced vegetables comprise:
a) daikon;
b) carrots;
c) onions;
d) pickled olives; and
e) pickled cucumbers.

6. The bread as defined in claim 5, wherein said bread is a nonyeast type; and
wherein said bread further comprises:
a) all purpose flour;
b) baking powder;
c) baking soda;
d) salt;
e) sugar;
f) shortening;
g) large eggs; and
h) pumpkin powder.

7. The bread as defined in claim 6, wherein said all purpose flour is 3 cups;
wherein said baking powder is 1 teaspoon;
wherein said baking soda is 2 teaspoons;
wherein said salt is ¼ teaspoon;
wherein said sugar is 4 tablespoons;
wherein said shortening is ⅔ cup;
wherein said large eggs are 4; and
wherein said pumpkin powder is ½ cup.

8. The bread as defined in claim 7, wherein said powdered vegetables are 1½ cups;
wherein said concentrated liquid vegetables are ½ cup;
wherein said powdered grains are ½ cup; and
wherein said dehydrated diced vegetables are ½ cup.

9. The bread as defined in claim 5, wherein said bread is a yeast type; and
wherein said bread further comprises:
a) all purpose flour;
b) sugar;
c) yeast;
d) salt;
e) soy been milk;
f) shortening; and
g) large egg.

10. The bread as defined in claim 9, wherein said all purpose flour is 1½ cups;
wherein said sugar is 4 tablespoons;
wherein said yeast is one commercial packet;
wherein said salt is ¼ teaspoon;
wherein said soy been milk is ½ cup;
wherein said shortening is ⅓ cup; and
wherein said large egg is 1.

11. The bread as defined in claim 10, wherein said powdered vegetables are ½ cup;
wherein said concentrated liquid vegetables are ½ cup;
wherein said powdered grains are ½ cup; and
wherein said dehydrated diced vegetables are ½ cup.

12. A method for preparing powdered vegetables for use in a bread utilizing vegetables for their nutritional value, comprising the steps of:
a) dehydrating vegetables by sun light or heat treatment so as to form dehydrated vegetables;
b) milling the dehydrated vegetables into power form so as to form powdered vegetables; and
c) mixing the powdered vegetables well so as to form the vegetables in powder form.

13. A method for preparing concentrated liquid vegetables for use in a bread utilizing vegetables for their nutritional value, comprising the steps of:
a) chopping the vegetables into fine pieces so as to form chopped vegetables;
b) pouring the chopped vegetables into an earthen Jar with a large mouth, a dark glass container, or a dark thick plastic container so as to form contained vegetables;
c) pouring enough natural spring water to cover the contained vegetables so as to form watered vegetables;
d) sprinkling natural sea salt lightly over the watered vegetables so as to form contents;
e) covering the earthen jar with the large mouth, the dark glass container, or the dark thick plastic container so as to form a covered container;
f) placing the covered container in a dark cool place for three (3) weeks to ferment, shaking or stirring once a day;
g) removing the contents;
h) placing the contents in a presser to extract as much liquid as possible so as to form extracted contents;
i) filtering liquid out of the extracted contents so as to form filtered contents;
j) placing the filtered contents into another earthen jar with a large mouth, a dark glass container, or a dark thick plastic container;
k) vacuum sealing the earthen jar with the large mouth, the dark glass container, or the dark thick plastic container; and
l) storing in a cool place or refrigerate.

14. A method for preparing powdered grains for use in a bread utilizing vegetables for their nutritional value, comprising the step of milling the grains into a fine powder.

15. A method for preparing dehydrated diced vegetables for use in a bread utilizing vegetables for their nutritional value, comprising the steps of:
a) dicing the vegetables so as form diced vegetables; and
b) dehydrating the diced vegetables by sun light or heat treatment so as to form the dehydrated diced vegetables.

16. A method for making non-yeast bread utilizing vegetables for their nutritional value, comprising the steps of:
a) sifting together in a large bowl all purpose flour, baking powder, baking soda, powdered grains, and powdered vegetables so as to form a first composition;
b) mixing together in another large bowl, shortening, sugar, and egg so as to form a second composition;
c) beating the second composition until light and fluffy so as to form a beaten composition;
d) adding to the beaten composition pumpkin powder, dehydrated diced vegetables, and concentrated liquid vegetables so as to form a third composition;
e) mixing the third composition well so as to form a mixed composition;
f) adding the mixed composition to the first composition so as to form a fourth composition;
g) adding the powdered vegetables to the fourth composition so as to form a fifth composition;
h) mixing the fifth composition until blended so as to form a blended composition;
i) pre-heating an oven to 325 degrees F.;
j) greasing a 1 lb. loaf pan;
k) adding the blended composition into the 1 lb. loaf pan; and
l) baking for about 1½ hours.

17. A method for making a yeast bread utilizing vegetables for their nutritional value, comprising the steps of:
a) sifting together in a large bowl all purpose flour, powdered grains, sugar, commercial yeast, salt, and powdered vegetables so as to form a first composition;
b) mixing together in another large bowl concentrated liquid vegetables, soy bean milk, and shortening so as to form a second composition;
c) heating the second composition to 120 degrees F. so as to form a heated composition;
d) adding the heated composition gradually to the first composition so as to form a third composition;
e) beating the third composition for 2 minutes at medium speed, scrapping the large bowl occasionally so as to form a first beaten composition;
f) adding to the first beaten composition egg and all purpose flour so as to form a fourth composition;
g) beating the fourth composition for 2 minutes at high speed, scrapping the large bowl occasionally so as to form a second beaten composition;
h) stirring dehydrated diced vegetables into the second beaten composition so as to form a stirred composition;
i) greasing a 1 lb. loaf pan;
j) adding the stirred composition into the 1 lb. loaf pan;
k) covering the 1 lb. loaf pan with plastic wrap;
l) letting the stirred composition rise in a warm draft free area until double in bulk;
m) pre-hating an oven to 325 degrees F.; and
n) baking for about 25 minutes.
